(19) United States
(12) Patent Application Publication
(10) Pub. No.: US 2002/0164413 A1
(43) Pub. Date: Nov. 7, 2002

(54) Method for flavoring an olive oil

(75) Inventors: Stella Sophia Van Boom, Vlaardingen (NL); Rob Van der Brugghen, Vlaardingen (NL); Reinout Maitland, Vlaardingen (NL)

Correspondence Address: UNILEVER, PATENT DEPARTMENT, 45 RIVER ROAD, EDGEWATER, NJ, 07020, US

(73) Assignee: Lipton, Division of Conopco, Inc.

(21) Appl. No.: 10/025,295

(22) Filed: Dec. 19, 2001

(30) Foreign Application Priority Data
Dec. 22, 2000 (EP) 00204713.2

(51) Int. Cl. A23D 7/00

(52) U.S. Cl. 426/613

(57) ABSTRACT

A process for the manufacture of a flavoured olive oil, comprising the steps of:

mixing olives with one or more flavoring agents;

subjecting the mixture to a crushing and malaxation treatment obtaining a malaxation mash;

separating the flavored olive oil from the malaxation mash;

collecting the flavored olive oil.

The present invention relates to a method of preparing a flavored olive oil and to the flavored olive oil obtained therewith. Flavored oils are convenient means to flavor foods and are useful as condiments or cooking ingredients. For example, an oil flavored with onion can be used for frying. Another use is as a means to flavor meals, such as pasta, meat, fish, salads etc. or as a basis for a marinade.

### BACKGROUND OF THE INVENTION

In the prior art many ways of flavoring oils are provided. One of the basic methods is the addition of the flavoring agent to the oil and leaving the oil to stand for a certain amount of time, such as described in GB 1 237 042. In this way oils flavored with herbs, such as rosemary are prepared. A drawback of this method is that it can take a relatively long time for the oil to absorb the flavor. Also, the added flavoring agent will often remain in the oil, which is not desirable for some applications. Another drawback is that this extraction method does not yield an optimal flavor profile.

It is also possible to add to an oil synthetic flavors or natural flavor extracts (for instance those obtained according to U.S. Pat. No. 3,860,734). However, many consumers do not appreciate the addition of a flavor which is synthetic, because they rather prefer a naturally flavored product. However, using extracts to flavor the oil, generally is not very economical, as processes to prepare extracts can be complicated and make the product expensive.

A further method of flavoring an oil is described in U.S. Pat. No. 5,320,862. According to this method a vegetable oil is contacted with a garlic or onion flavoring agent in a particulate form at a temperature between 100 and 200° C. A drawback of this method is that the oil needs to be heated, which can result in a change in taste and flavor of the oil and a reduction in oil quality.

### SUMMARY OF THE INVENTION

The present invention provides a process for the manufacture of a flavoured olive oil, comprising the steps of:

mixing olives with one or more flavoring agents;

subjecting the mixture to a crushing and malaxation treatment obtaining a malaxation mash;

separating the flavored olive oil from the malaxation mash;

collecting the flavored olive oil.

### DETAILS OF THE INVENTION

The present process applies the conventional process steps for preparing an olive oil but admixes the flavoring agent with the starting olives. During the step of crushing and malaxation of the mixture of olives and flavoring agents, flavors are transferred from the flavoring agent to the oil. In this manner the flavors from the flavoring agents are very well absorbed into the oil and the residue of the flavoring ingredient will be separated from the oil together with the olive residue. Thus, the process results in a clear olive oil.

It is known to add “foreign” material to the olives during crushing and malaxation, but such ingredients are intended merely to increase the oil yield. In WO 87/06606, for instance, it is described to add maize or corn to oil seeds or to fruits. The grains of maize are recovered and recycled into the press.

The process of the invention can further include the steps of preparing the olives for the process by removal of olive leaves and washing of the olives. The step of separating the oil from the malaxation mash can be carried out by decanting and/or centrifugation both of which are conventional steps in the olive oil production process.

Generally, crushing and malaxation of the mixture takes place at a temperature of 10-50° C.

The present invention offers a method for manufacturing a flavored olive oil with an excellent taste and flavor profile. The oil is clear and also has a better anti-oxidant activity. Another advantage of the present process is that it delivers an oil with a high flavor stability. This effect is attributed to the in-situ extraction method comprising crushing the flavoring agents and so activating flavor generation. The in-situ generated flavours are immediately absorbed into the oil which enables preservation of characteristic flavor compounds which are either not generated or are unstable when employing known flavouring procedures.

According to a further aspect of the invention the process is applied with an existing oil which equally applies to oils different from olive oil. This process comprises the step of

mixing an oil with one or more flavoring agents;

subjecting the mixture to a crushing and malaxation step;

separating the flavored oil from the residual flavoring agents;

collecting the flavored oil.

The oil used in this process can be any vegetable or animal oil suitable for consumption, but preferably is an olive oil.

The crushing and malaxation step is similar to the well known steps carried out when harvesting olive oil, but using solely the flavouring agent instead of the olives together with flavouring agent. At wish olives may be added to the mixture.

The flavoring agents according to the invention are preferably foodstuffs, in particular natural non-processed foodstuffs. The following groups of foodstuffs can be used as flavoring ingredient:

1. Herbs, in particular oregano, basil, thyme, coriander, dill, rosemary, peppermint, chives, sage, parsley and estragon.

2. Vegetables, in particular paprika's, tomatoes and dried tomatoes.

3. Fruits, in particular apples and banana's.

4. Garlic and/or onion.

5. Mushrooms, in particular truffles.

6. Spices, in particular pepper, cloves, nutmeg and ginger.

7. Nuts, in particular almonds, hazel nuts and pine nuts.

A further flavoring ingredient that can also be used according to the invention is grass.

The flavoring agent is added to the olives in an amount of 0.1% to 200%, preferably 0.5 to 50%, most preferably 0.5 to 20% in relation to the total weight of the olives or to the oil when the flavouring agent is added to a ready oil.

According to a preferred embodiment of the invention the olives are mixed with herbs that impart a flavor profile that can increase the concentration of a number of flavor compounds characteristic for olive oil. This offers a relatively simple method for enriching the olive oil flavor. The flavor profile of the olive oil before and after the treatment with the flavoring agent can be determined by degassing of the resulting oil under high vacuum followed by analysis of the resulting extract by gas chromatography. Preferred additives for improving the flavor profile of olive oil are apple, banana or grass.

The obtained olive oil can be used in the preparation of food products, such as spreads, salad dressings and sauces. It is also possible to mix the olive oil with another edible oil, to improve its taste. The other edible oil can be a neutrally tasting vegetable oil such as sunflower oil, rape seed oil or corn oil but also can be an olive oil, such as a refined olive oil.

### BRIEF DESCRIPTION OF THE FIGURES

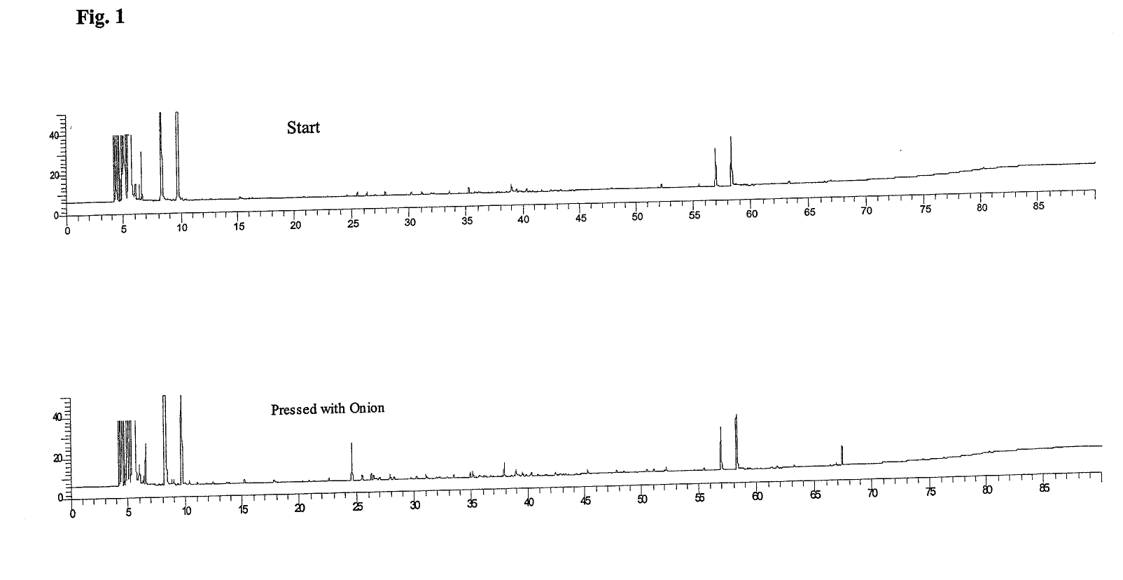

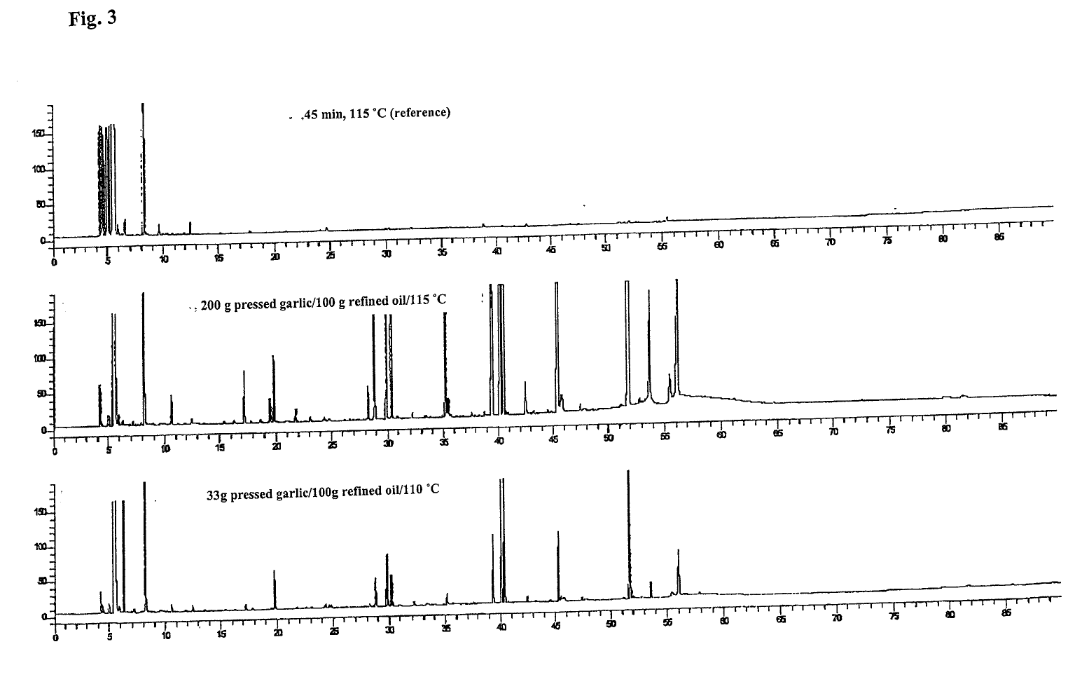

The invention is further illustrated by FIGS. 1 to 7. FIGS. 1, 2, 6 and 7 show flavor profiles of olive oils treated with flavoring agents according to the invention and, specifically, according to examples 1 to 4, respectively. For comparison FIGS. 3, 4 and 5 show flavor profiles of oils treated with garlic according to the state of the art.

### EXAMPLES

Flavor analysis was carried out according to the protocol “Flavour analysis in olive oil with herbs” as specified below.

### Example 1

To olives 14 wt. % onions were added. This mixture was crushed in a lab scale hammer crusher. The resulting paste was malaxed for 30 minutes at room temperature. The oil was separated from the mixture by centrifugation (at 3500 rpm for 2 minutes). This oil had an induction time of 9.8 h. The flavor profile was characterized by degassing the oil and analyzing the resulting extract by gas chromatography. Flavor compounds were characterized using mass spectrometry. FIG. 1 shows the flavor profile, whereas Table 1 shows the flavor compounds.

### Example 2

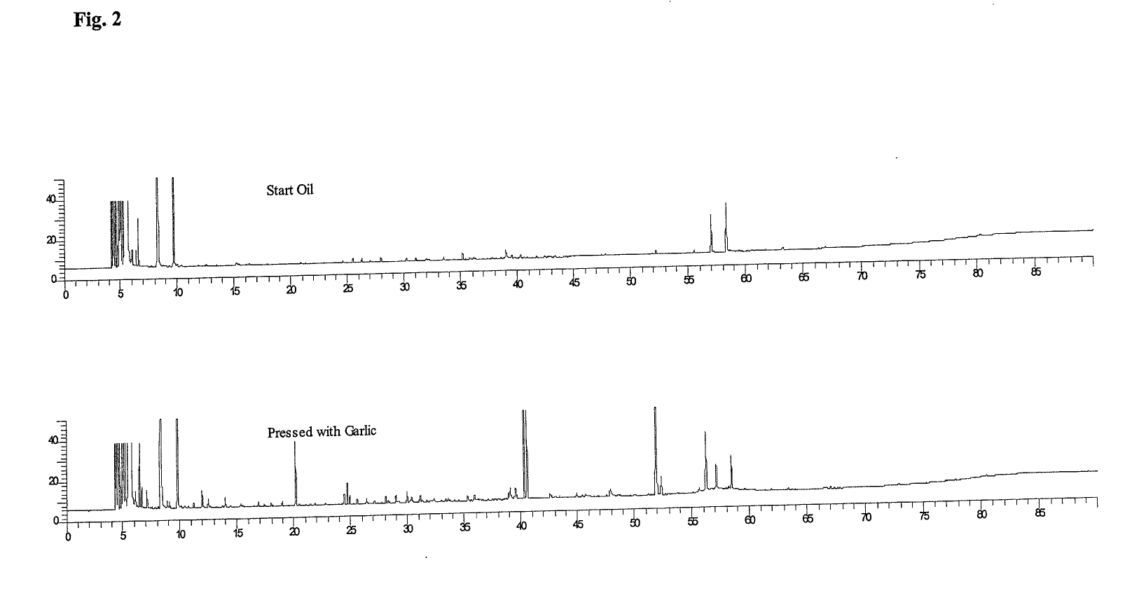

To olives 10 wt. % of garlic was added. This mixture was crushed in a lab scale hammer crusher. The resulting paste was malaxed for 30 minutes at room temperature. The oil was separated from the mixture by centrifugation (at 3500 rpm for 2 minutes). This oil had an induction time of 11.8 h. The flavor profile was characterized by degassing the oil and analyzing the resulting extract by gas chromatography. Flavor compounds were characterized using mass spectrometry. FIG. 2 shows the flavor profile, whereas Table 1 shows the flavor compounds.

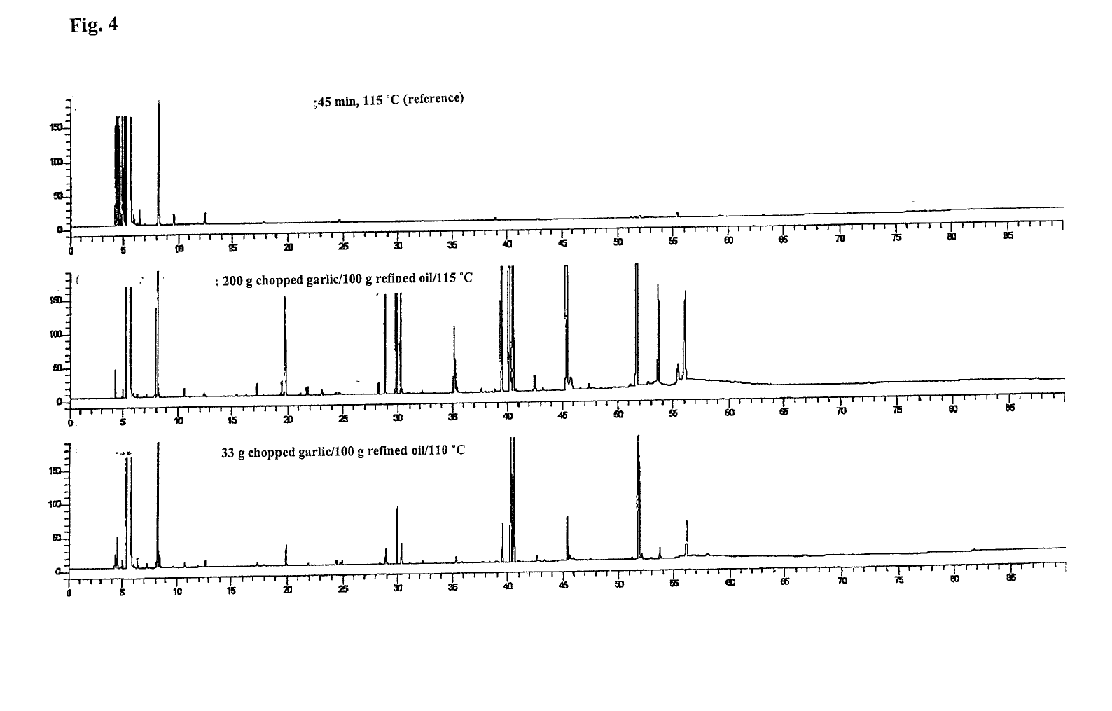

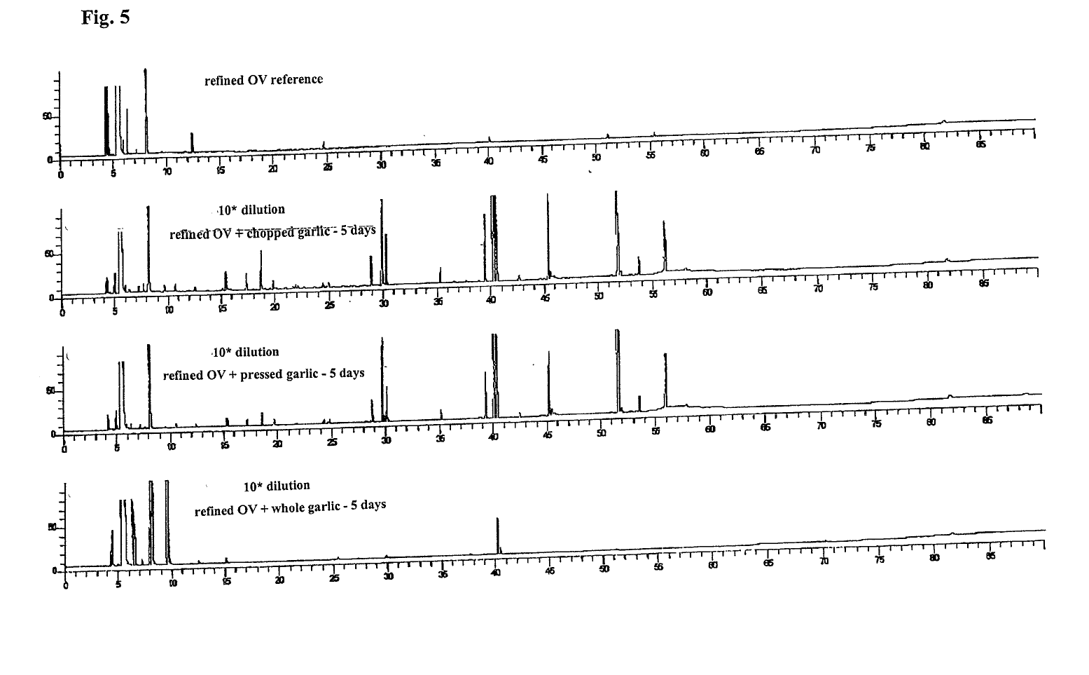

For comparison chopped or pressed garlic was added to a refined olive oil, heated to a temperature of 100-115 ° C. The flavor profiles are shown in FIG. 3 and 4, respectively. Also chopped, pressed or whole garlic was added to a refined olive oil and the oil was left to stand for 5 days. Flavor profiles are shown in FIG. 5.

### Example 3

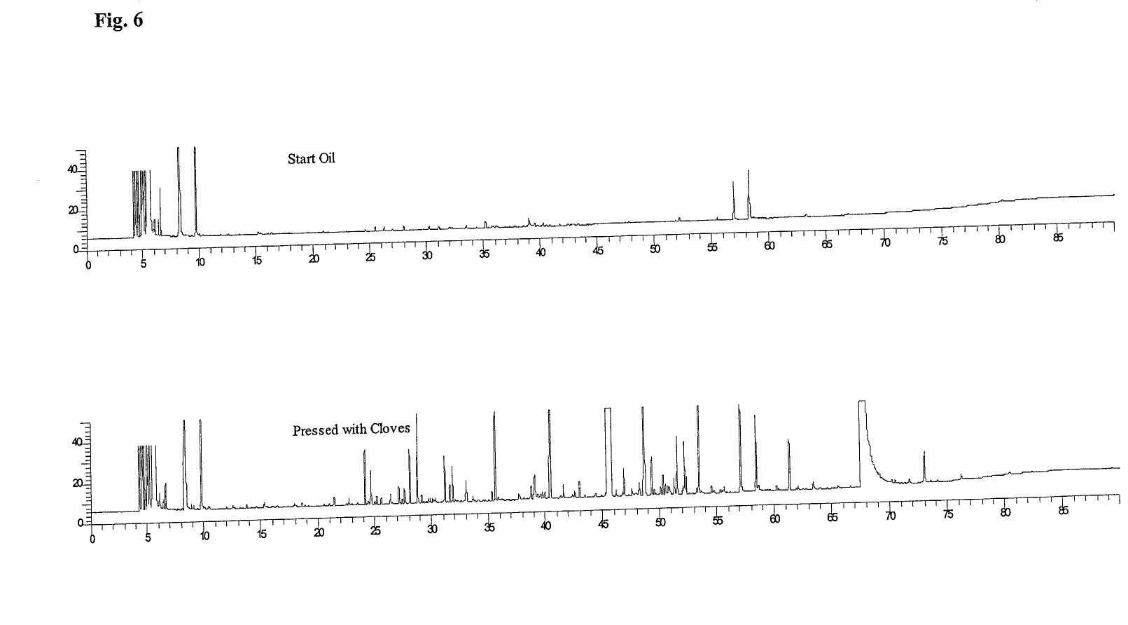

To olives 0.9 wt. % of cloves were added. This mixture was crushed in a lab scale hammer crusher. The resulting paste was malaxed for 30 minutes at room temperature. The oil was separated from the mixture by centrifugation (at 3500 rpm for 2 minutes). This oil had an induction time of 9.8 h. The flavor profile was characterized by degassing the oil and analyzing the resulting extract by gas chromatography. Flavor compounds were characterized using mass spectrometry. FIG. 6 shows the flavor profile, whereas Table 1 shows the flavor compounds.

### Example 4

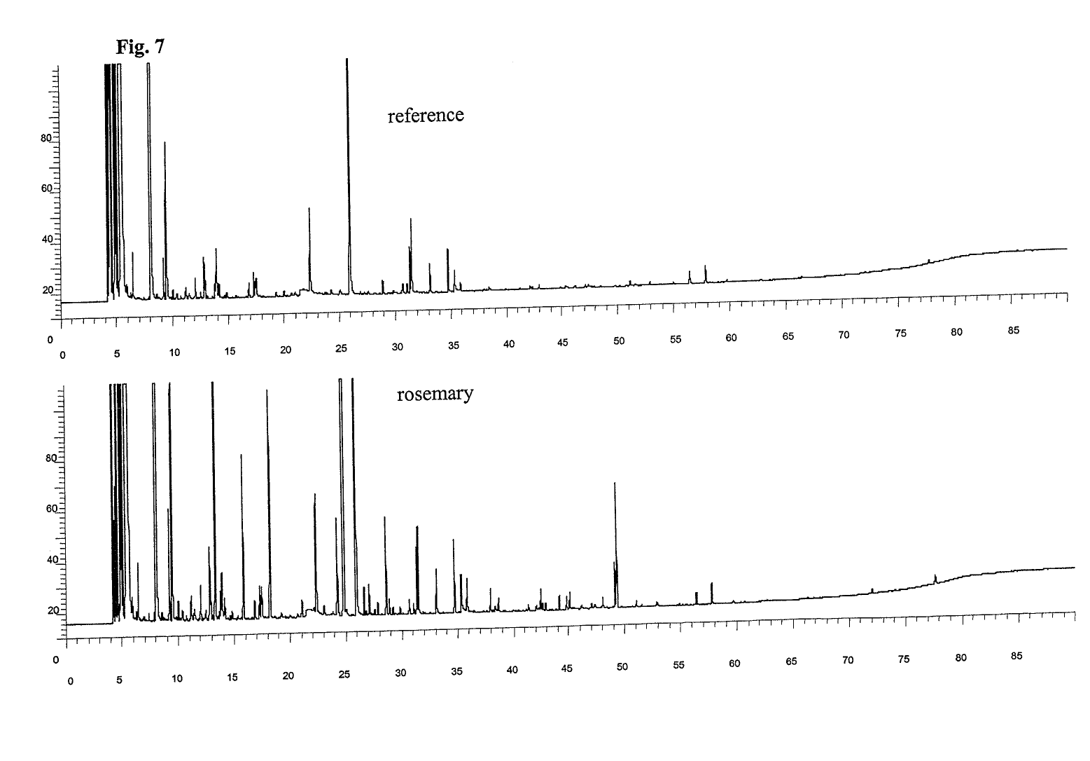

To olives 0.5 wt. % of rosemary leaves were added. This mixture was crushed in a lab scale hammer crusher. The resulting paste was malaxed for 30 minutes at room temperature. The oil was separated from the mixture by centrifugation (at 3500 rpm for 2 minutes). This oil had an induction time of 15.1 h. The flavor profile was characterized by degassing the oil and analyzing the resulting extract by gas chromatography. Flavor compounds were characterized using mass spectrometry. FIG. 7 shows the flavor profile, whereas Table 2 shows the flavor compounds. This oil was also tasted by a trained olive oil panel in Greece and the oil was described as having a not artificial, but delicate natural rosemary scent.

TABLE 1

| Flavor compounds | | | | Reference |
|---|---|---|---|---|
| μg/kg oil | Garlic | Onion | Cloves | oil |
| Ethylisobutanoate | 3 | 3 | 3 | 3 |
| pentanone-3 | 68 | 27 | 3 | 17 |
| 1-pentene-3-one | 3 | 3 | 3 | 3 |
| ethyl-2-methyl-butanoate | 3 | 3 | 33 | 3 |
| Hexanal | 296 | 35 | 69 | 13 |
| Ethylbenzene | 3 | 13 | 3 | 3 |
| butanol-1 | 80 | 9 | 11 | 9 |
| 1-pentene-3-ol | 8 | 40 | 6 | 9 |
| Heptanal | 1228 | 24 | 400 | 26 |
| 3-methylbutanol-1 | 179 | 229 | 239 | 170 |
| 2-trans-hexenal | 276 | 274 | 375 | 192 |
| pentanol-1 | 285 | 215 | 111 | 143 |
| Hexylacetate | 10 | 3 | 34 | 3 |
| Octanal | 876 | 227 | 284 | 251 |
| 3-cis-hexenylacetate | 20 | 14 | 1335 | 11 |
| 2-trans-heptenal | 120 | 16 | 42 | 20 |
| hexanol-1 | 114 | 109 | 158 | 103 |
| 3-cis-hexenol | 164 | 3 | 290 | 197 |
| Nonanal | 764 | 328 | 340 | 212 |
| 2-trans-hexenol | 19 | 12 | 54 | 18 |
| 2-trans-octenal | 38 | 15 | 157 | 13 |
| acetic acid | 980 | 854 | 2170 | 93 |
| 2-trans, 4-cis- | 171 | 182 | 57 | 122 |
| heptadienal | | | | |
| Alloaromadendrene * | 3 | 3 | 3 | 3 |
| alpha-copaene * | 3 | 3 | 3 | 3 |
| 2-trans-, 4-trans- | 83 | 26 | 20 | 3 |
| heptadienal | | | | |
| 2-trans-nonenal | 461 | 3 | 3 | 3 |
| octanol-1 | 206 | 79 | 62 | 91 |
| butanoic acid | 54 | 52 | 1936 | 47 |
| 2-trans-decenal | 744 | 328 | 703 | 451 |
| nonanol-1 | 1425 | 1040 | 398 | 610 |
| 2-trans, 4-trans- | 131 | 67 | 53 | 3 |
| nonadienal | | | | |
| sesquiterpene * | 3 | 3 | 3 | 3 |
| pentanoic acid | 79 | 47 | 1260 | 31 |
| alpha-farnesene | 79 | 91 | 6369 | 34 |
| 2-trans, 4-cis-decadienal | 2300 | 3055 | 771 | 3 |
| 2-trans, 4-trans- | 3 | 218 | 3 | 3 |
| decadienal | | | | |
| 2-methyl-butanal (8.70) | 248 | 206 | 181 | 49 |
| ethylbutanoate (14.79) | 3 | 3 | 3 | 79 |
| 18, 23 | 19 | 19 | 19 | 13 |
| 1-octene-3-one (30.58) | 84 | 158 | 30 | 12 |
| 3-octene-2-one (35.40) | 8 | 3 | 22 | 8 |
| Ethylcyclohexanoate | 3 | 3 | 3 | 3 |
| (36.82) | | | | |
| isovaleric acid (47.72) | 68 | 93 | 3 | 41 |
| 2-phenylethanol (57.70) | 4180 | 6301 | 7432 | 5402 |
| 3-cis-hexenal | 86 | 31 | 21 | 26 |
| Ethanol (9.35) | 10373 | 10596 | 11065 | 9334 |
| 10, 08 | 3 | 153 | 82 | 24 |
| 13, 2 | 3 | 3 | 10 | 11 |
| 3-me-butanol-1 | 106 | 80 | 153 | 90 |

TABLE 2

| | | reference |
|---|---|---|
| Flavor compounds μg/kg oil | rosemary | oil |
| Ethylisobutanoate | 3 | 3 |
| pentanone-3 | 490 | 287 |
| 1-pentene-3-one | 1659 | 1741 |
| ethyl-2-methyl-butanoate | 3 | 57 |
| Hexanal | 1639 | 1040 |
| Ethylbenzene | 41 | 71 |
| butanol-1 | 7 | 9 |
| 1-pentene-3-ol | 3469 | 1789 |
| Heptanal | 330 | 72 |
| 2/3-methylbutanol-1 | 367 | 29 |
| 2-trans-hexenal | 23776 | 19331 |
| pentanol-1 | 142 | 72 |
| Hexylacetate | 524 | 402 |
| Octanal | 510 | 230 |
| 3-cis-hexenylacetate | 2003 | 2503 |
| 2-trans-heptenal | 105 | 73 |
| hexanol-1 | 1084 | 699 |
| 3-cis-hexenol | 1723 | 1019 |
| Nonanal | 4045 | 2013 |
| 2-trans-hexenol | 872 | 216 |
| 2-trans-octenal | 29 | 39 |
| acetic acid | 838 | 351 |
| 2-trans, 4-cis-heptadienal | 43 | 38 |
| Alloaromadendrene * | 12 | 10 |
| alpha-copaene * | 3 | 3 |
| 2-trans-, 4-trans-heptadienal | 26 | 9 |
| 2-trans-nonenal | 367 | 180 |
| octanol-1 | 339 | 207 |
| butanoic acid | 312 | 175 |
| 2-trans-decenal | 1015 | 680 |
| nonanol-1 | 714 | 327 |
| 2-trans, 4-trans-nonadienal | 218 | 173 |
| sesquiterpene * | 23 | 3 |
| pentanoic acid | 72 | 48 |
| alpha-farnesene | 638 | 540 |
| 2-trans, 4-cis-decadienal | 3 | 3 |
| 2-trans, 4-trans-decadienal | 3 | 3 |
| 2-methyl-butanal (8.70) | 203 | 136 |
| ethylbutanoate (14.79) | 218 | 59 |
| 18, 23 | 8096 | 58 |
| 1-octene-3-one (30.58) | 65 | 37 |
| 3-octene-2-one (35.40) | 17 | 21 |
| Ethylcyclohexanoate (36.82) | 3 | 3 |
| isovaleric acid (47.72) | 39 | 39 |
| 2-phenylethanol (57.70) | 1635 | 1329 |
| 3-cis-hexenal | 3686 | 2133 |
| Ethanol (9.35) | 8115 | 4731 |
| 10, 08 | 447 | 275 |
| 13, 2 | 135 | 3 |
| 3-me-butanol-1 | 75 | 8 |

### Flavour Analysis in Olive Oil Treated with Herbs

The analysis procedure contains at least two steps:

1. Degassing (always)

2. GLC-FID analysis (always)

3. GLC-MS analysis (optional for identification)

The first two steps are standard and sufficient, since the olive oils extracts have a recognisable GLC-FID pattern. However, when additional flavour compounds are added to the olive oil e.g. by means of herbs, deviations from the standard pattern were observed and additional mass spectrometric detection was necessary to identify the unknown compounds.

1. Degassing as Sample Isolation

The olive oil raw material is centrifuged at room temperature with 8000 rpm (or 10000 g) during 25 minutes, using a Sorvall RC-5B superspeed refrigerated ultra centrifuge. After centrifugation, 100 grams of olive oil is subjected to high vacuum degassing at p=0.1 mPa, 30° C. during 5 hours, to isolate the volatile compounds in a U-tube ‘cold trap’ (liquid nitrogen).

The extract is dissolved in 2.0 ml methylformiate (gold label ex. Aldrich), to obtain a homogeneous mixture of the polar and non-polar materials and discarded from the U-tube. For the isolation of less volatile compounds in the olive oil, a similar procedure as described above is used, however, the extraction was performed at a temperature of 90° C.

2. GLC-FID Analysis

Capillary GLC-FID analysis is performed on a 60 m, 320 μm id. polar AT 1000 column (ex. Altech) with a film thickness of 0.3 μm, using a Hewlett-Packard 5890 series II gas chromatograph (or similar system).

| | |
|---|---|
| Splittervent: | 25 ml/min |
| Injection temperature: | 250° C. |
| Detection temperature: | 275° C. |
| Detector: | Flame Ionisation Detection (FID) |
| Carrier gas: | He |
| Linear gas velocity: | 23.75 cm/s |
| Initial column temperature: | 60° C. (during the first 10 minutes) |
| Temperature gradient: | 3° C./minute |
| Final column temperature: | 250° C. |

Quantitative analysis could be performed with this GC-FID method. Recoveries of the key volatiles were determined by spiking MCT-oil at 50 and 500 ppb level. The degassing was performed at 30 and 90° C., with recovery ranges of 50-80% and 80-100%, respectively, depending on the polarity of the aroma substances.

The concentrations of the volatiles are calculated from the peak areas in the chromatograms towards nonanal as an external standard. The following formula is used to calculate the

$$\frac{A {R}_{f}}{{A}_{1}} \frac{{V}_{1}}{{V}_{2}} \frac{1000}{I} \frac{100}{R} = μ g aroma compound \text{/} kg oil$$

concentration of the volatiles:

A=GC area of the volatile aroma compound

A1=GC area of 1 μg nonanal external standard

V1=Volume of methylformiate (μl) added to the U-tube

V2=Injection volume (μl)

I=Amount of degassed olive oil (gram)

R=Response factor of the aroma compound with regards to nonanal

R=Recovery of the volatile (%)

The amounts of volatiles that are found in various olive oils correspond well with some literature values [Guth et al., J. Am. Oil Chem. Soc., 70 (1993) 513], based on stable-isotope dilution analysis.

3. GLC-MS Analysis

Capillary GLC-MS analysis is performed on a 25 m, 250 μm id. CPWax 58 CB column with a film thickness of 0.2 μm, using a Hewlett-Packard 6890 series gas chromatograph and Hewlett-Packard 5973 mass spectrometer (or similar systems).

The following system conditions were used:

Gas Chromatograph

| | |
|---|---|
| Splittervent | 16.5 ml/min |
| Injection temperature | 250° C. |
| Detection temperature | 275° C. |
| Detector | Mass Spectrometer |
| Carrier gas | He |
| Gas flow | 1 ml/min |
| Initial column temperature | 40° C. (during the first 10 minutes) |
| Temperature gradient | 3° C./minute |
| Final column temperature | 250° C. (for 3 minutes) |

Mass Spectrometer

| | |
|---|---|
| Scan mode | EI full scan |
| Electron energy | 70 eV |
| Scan range | m/z 29-350 |
| Scan speed | 3 scans/s |
| Interface temperature | 250° C. |
| Source temperature | 230° C. |
| Quad temperature | 150° C. |

1. A process for the manufacture of a flavoured olive oil, comprising the steps of:
mixing olives with one or more flavoring agents;
subjecting the mixture to a crushing and malaxation treatment obtaining a malaxation mash;
separating the flavored olive oil from the malaxation mash;
collecting the flavored olive oil.

2. A process according to claim 1, wherein the one or more flavoring agents are foodstuffs.

3. A process according to claim 2, wherein the one or more flavoring agents are selected from green herbs, garlic, onion, spices, mushrooms, nuts, fruits and vegetables.

4. A process according to claim 3, wherein the one or more flavoring agents are selected from green herbs, fruits and vegetables.

5. A process according to claim 3, wherein the green herbs are selected from the group consisting of oregano, basil, thyme, coriander, dill, rosemary, sage, peppermint, chives, parsley and estragon.

6. A process according to claim 3, wherein the fruits are selected from the group consisting of banana's and apples.

7. A process according to claim 3, wherein the vegetables are selected from the group consisting of paprika's, tomatoes and dried tomatoes.

8. A process according to claim 3, wherein the spices are selected from the group consisting of pepper, cloves, nutmeg and ginger.

9. A process according to claim 3, wherein the mushrooms are selected from truffles.

10. A process according to claim 3, wherein the nuts are selected from the group consisting of almonds, hazel nuts and pine nuts.

11. A process according to claim 1, wherein the flavoring ingredient is grass.

12. A process for the manufacture of a flavoured oil comprising the steps of
mixing an oil with one or more flavoring agents selected from green herbs, garlic, onion, spices, mushrooms, fruits and vegetables;
subjecting the mixture to a crushing and malaxation step;
separating the flavored oil from the residual flavoring agents;
collecting the flavored oil.
